(19) United States
(12) Patent Application Publication
(10) Pub. No.: US 2012/0304473 A1
(43) Pub. Date: Dec. 6, 2012

(54) Bolt cutters with breakdown handles

(76) Inventors: Michael Panosian, Glendale, CA (US); James Stobar, Los Angeles, CA (US); Josh Keeler, Glendale, CA (US)

(21) Appl. No.: 13/199,891

(22) Filed: Sep. 12, 2011

Related U.S. Application Data
(60) Provisional application No. 61/403,158, filed on Sep. 10, 2010.

(51) Int. Cl. B26B 17/00

(52) U.S. Cl. 30/192

(57) ABSTRACT

A collapsible bolt cutter includes compound levers a first lever of which includes elongate handles and a second lever of which includes cutting jaws for transmitting a force applied to the handles to the cutting jaws with a mechanical advantage when the handles are urged to move towards each other. The handles are each split along their length to form free handle portions articulated to the second levers. Locks or latches a provided for selectively locking the handle portions in the aligned operative positions during normal use while being manually releasable to release the free handle portions to allow the free handle portions to be pivoted to a second folded position when not in use and for storage.

### BACKGROUND OF THE INVENTION

1. Field of the Invention

The present invention relates to hand tools and, more specifically, to bolt cutters with breakdown handles.

2. Description of the Prior Art

traditional bolt cutters are large tools. Firstly, since bolt cutters are typically used to cut padlocks, chains, bolts and other very hard work pieces the tools must be made to provide significant mechanical advantages. For this reason, compound lever systems would each one of which provides its own mechanical advantage so that the be all mechanical advantage of the two is the product of mechanical advantages of each of the lever systems. Secondly, because significant cutting forces must be produced the first lever system that includes the handles and handgrips to which a user replies a manual force include handles the length of which is proportional to the mechanical advantage generated. The longer the handles, therefore, the greater the mechanical advantage and that was force a user needs to apply for a given cutting force. For this reason, are available in lengths from 12-42 inches.

The countered with traditional bolt cutters is that it is sheer size makes it difficult to impossible to carry on a tool belt were to fit within most standard toolboxes. This is true even for the smaller bolt cutters.

### SUMMARY OF THE INVENTION

accordingly, it is an object of the invention to provide a bolt cutter that is not possessed of the disadvantages inherent in prior art to bolt cutters.

It is another object of the invention to provide a bolt cutter that is simple in construction and economical to manufacture.

It is still another object of the invention to provide a bolt cutter that is a full-sized bolt cutter during use and is significantly reduced in size for purposes of transport and storage.

It is yet another object of the invention to provide a bolt cutter and has all the advantages of full-sized upon cutters but that can be carried on a tool belt or can fit into standard toolboxes.

It is an additional object of the invention to provide a bolt cutter of the type on the discussion that has collapsible handles but that does not in any way adversely affect the operation of bolt cutters.

It is a further object of the invention to provide a bolt cutter as in the previous objects that can be easily and conveniently collapsed after being used.

In order to achieve the above objects, as well as others that will become apparent hereinafter, a collapsible bolt cutter in accordance with the present invention comprises compound lever is a first lever of which includes elongation handles the second lever of which includes cutting jaws for transmitting it force applied to the handles to the cutting jaws with a mechanical advantage when the handles are urged to move towards each other. Said handles are each split the long hair length to form a three handle portion and an articulated portion joined through said second lever. If it means is provided for pivoting each of said three handle portions and associated articulated portions between a first operative position in which it said handle portions are aligned along a handle axis to form a composite and rigid elongation owned and a second storage position we're in a three handle portion is pivoted approximately hundred 180° to be positioned proximate to associated articulated portions and said second lever us. Blocking means is provided for selectively blocking said handle portions and settle line upper positions during normal use and releasing said three handle portions to allow said three handle portions to be pivoted to said second storage positions to effectively shortened but cutter when not in use.

### BRIEF DESCRIPTION OF THE DRAWINGS

Those skilled in the art will appreciate the improvements and advantages that arise from the present invention upon reading the following detailed description, claims and drawings, in which:

FIG. 1 is a perspective view of a bolt cutter with breakdown handles in accordance with the present invention, shown in the operative belt cutting position;

FIG. 2 is a side elevation view of the bolt cutter shown in FIG. 1;

FIG. 3 is a side elevation view of the bolt cutter shown in FIGS. 1 and 2 in the open, handles separated positions for inserting a work between the cutting jaws;

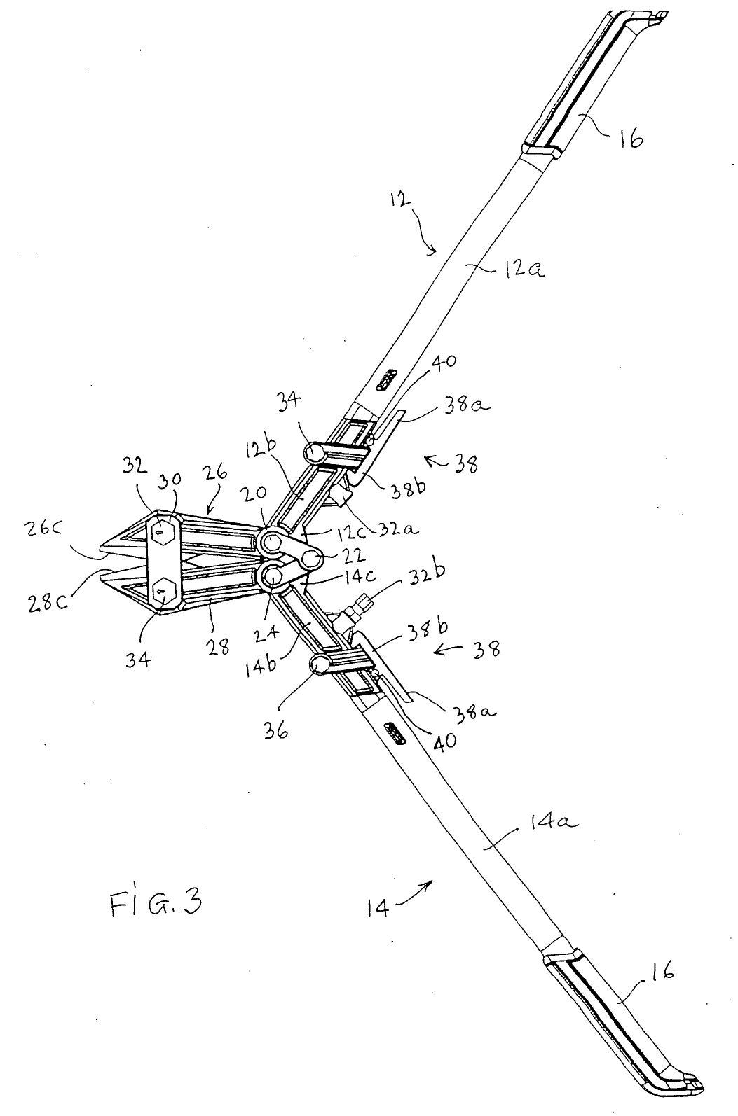

FIG. 4 is a sequence of side elevation with views illustrating how the handles of the pull cutter can be broken down or collapsed to shorten the effective length of the tool;

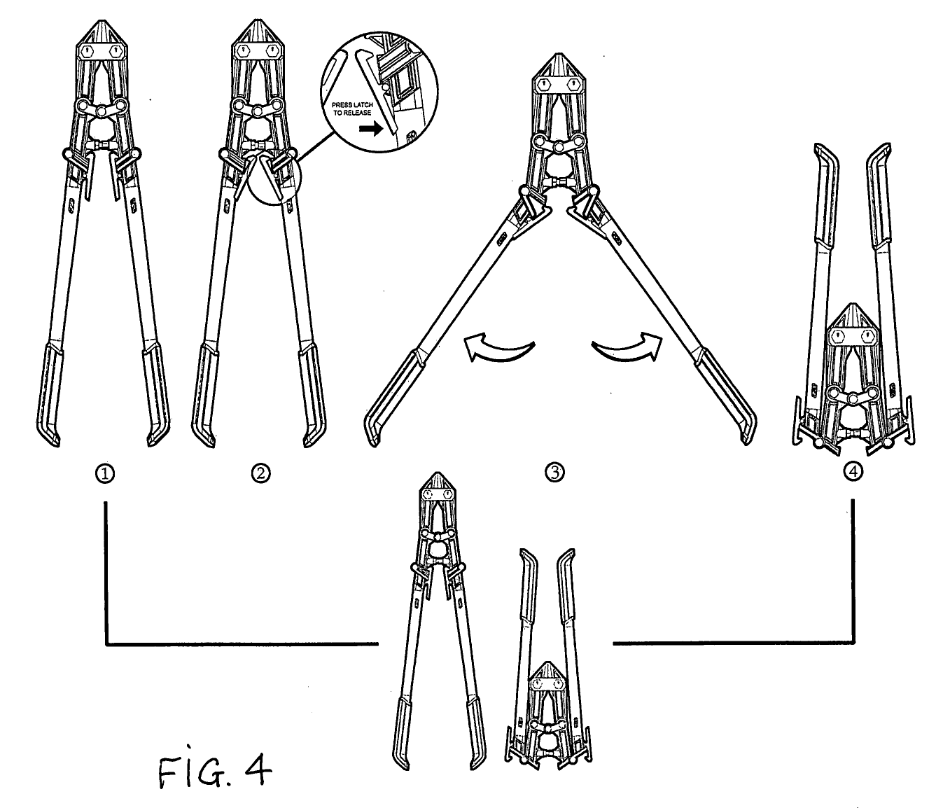

FIG. 5 is a sequence of perspective use suggesting have the handles of the bolt cutter are collapsed, folded or broken down;

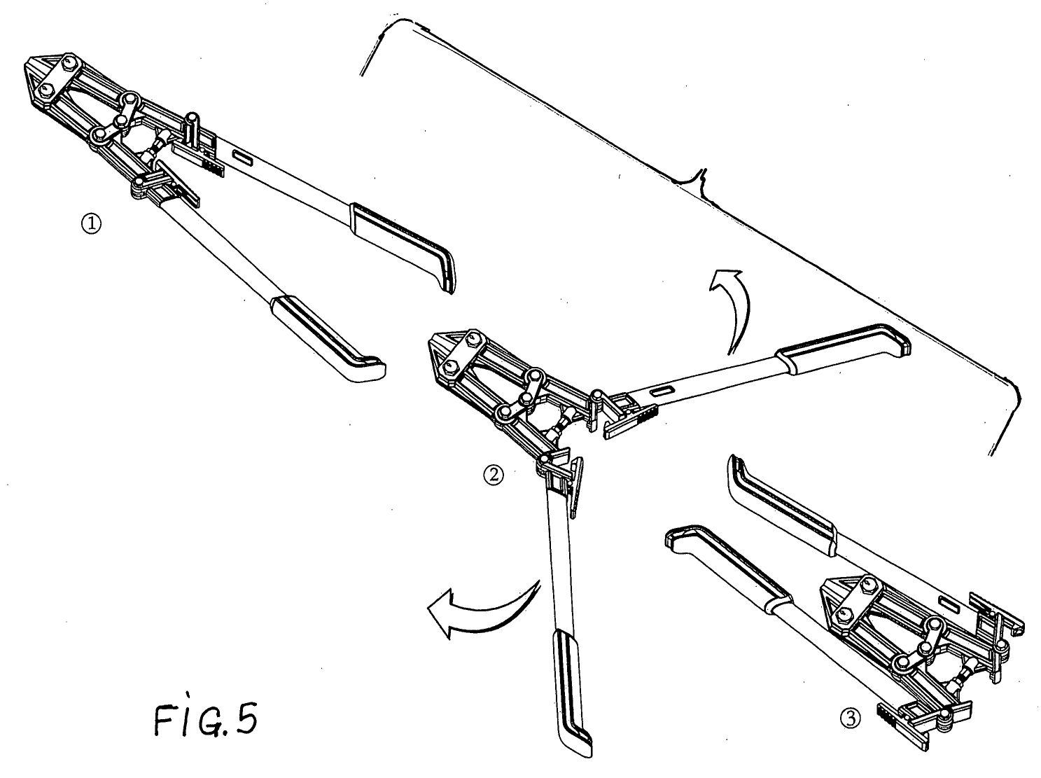

FIG. 6 is a side elevation view of the bolt cutter with his broken down or collapsed for storage; and

FIG. 7 is a perspective view of the collapsed or broken down of the pull cutter shown in fig six.

### DESCRIPTION OF PREFERRED EMBODIMENT

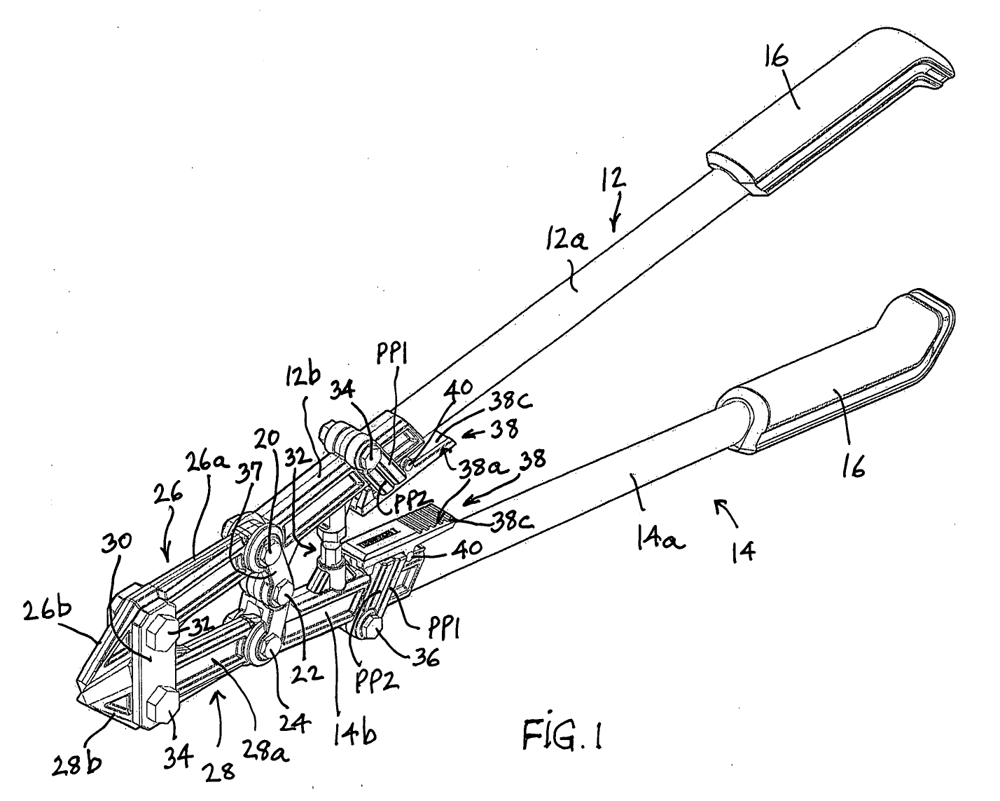

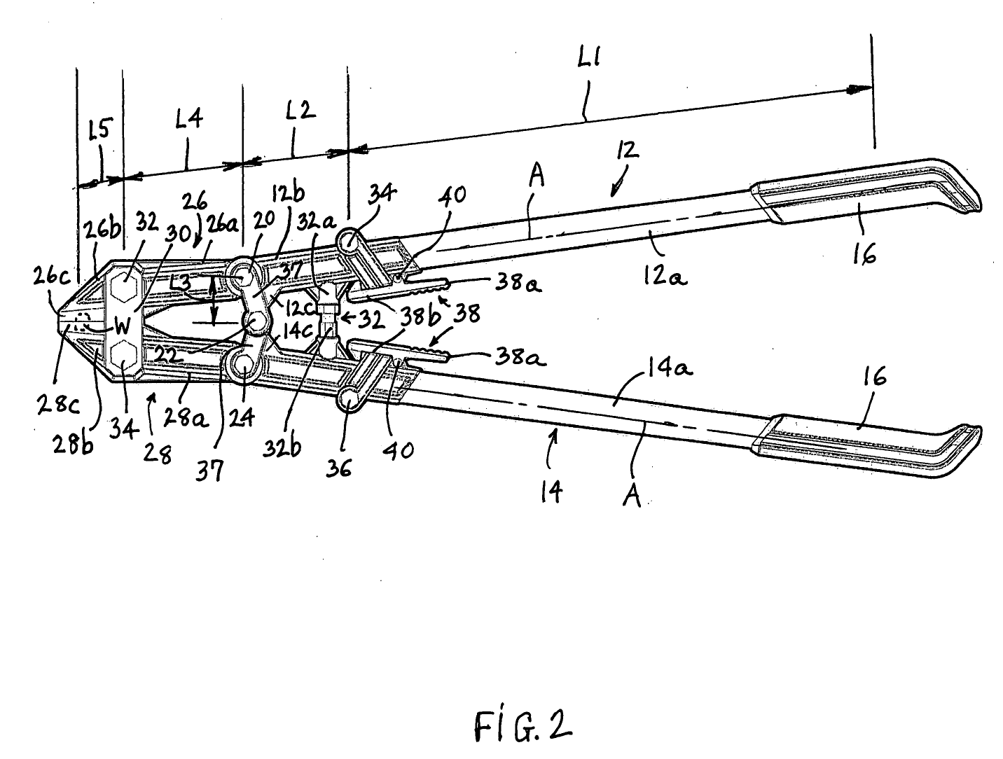

Referring now specifically to Fig.s, in which they identical or similar parts will be designated by the same reference numerals throughout, and first referring to FIGS. 1 and 2, a bolt cutter in accordance with the present invention is generally designated by the reference numeral 10.

For reasons that will become apparent, the specific type or style of bolt cutter is not critical for purposes of the present invention. However, the bolt cutter 10 illustrated is a compound lever arrangement. First lever arrangement includes levers 12, 14. As the lever 12 includes a first handle portion 12a and a second handle portion 12b the free end of which is secured to a pivot 20 and a substantially normal portion or extension 12c of which is secured to a pivot 22. Similarly, the lever 14 includes a first handle portion 14a and a second handle portions 12b the free end of which is secured to a benefit and 24 and a substantially normal portion or extension 14c of which is secured to the same pivot 22.

The length of the first handle portions 12a, 14a is L1 while the second handle portions 12b, 14b and a length L2. The total length L=L1+L2 represents the total length of the handle or lever arm of the first lever arrangement while the length L3 of the extension 12c represents the other lever arm of the first lever arrangement, so that the mechanical advantage of the first lever arrangement M1=L/L3.

The second lever arrangement is formed by levers 26, 28. Arms 26a, 28a are coupled to the pivots 20, 24, respectively, while the free ends 26b, 28b form the cutting jaws bearing and cutter ages 24c, 28c. The length of the arms 26a, 28a is L4 while the lengths of the free ends 26b, 28b is L5, the mechanical vantage of the second lever arrangement M2=L5/L4.

The levers 26, 28 are pivotally mounted on the plates 30 by means of a 33, 34. Links 37 couple pivots 20, 22 and 24 as shown.

And adjustable stop 32 consisting of adjustable spacers 32a, 32b one or both of which can be adjusted to increase or shorten the lengths to prevent the handles 12a, 14a from coming together after a bolt or the like has been cut, primarily to avoid injury to the user.

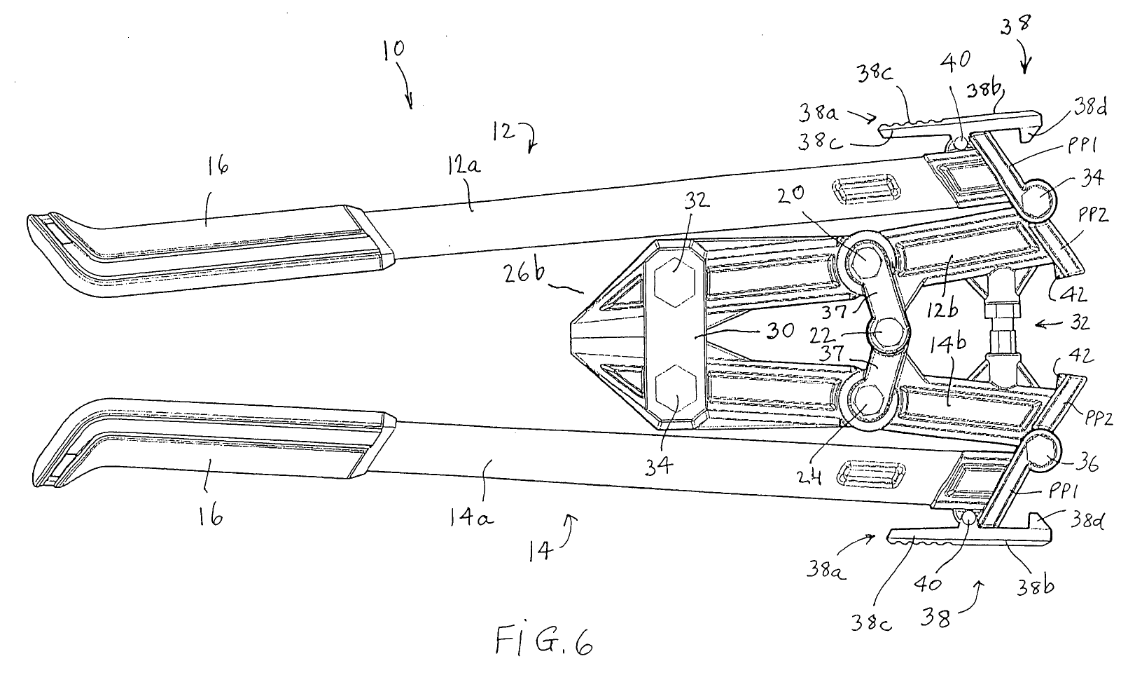

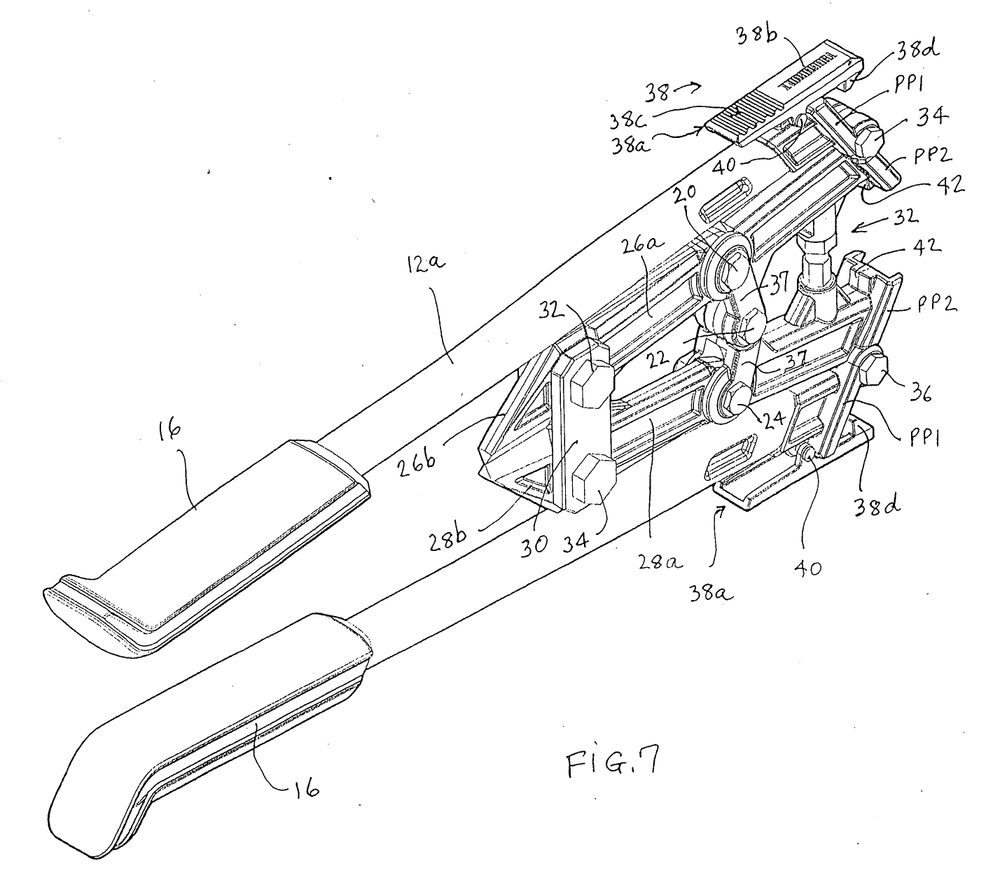

An important feature of the invention is the provision of pivots 34, 36 each for pivotally connected in handle portions 12a, 14a to associated articulated portions 12b, 14b for movement between extended operative positions shown, for example, in FIGS. 1 and 2 in which the handle portions are aligned award a handle axis to form a composite elongate handle and a second collapsed or folded condition in which the free handle portions 12a, 14a are pivoted approximately hundred 180° to be positioned proximate to associated articulated portions 12b, 14b as shown, for example, in FIGS. 6 and 7.

Referring, for example, to FIG. 6 levers 38 to are pivotally mounted on the handle portions 12a, 14a as shown. In the levers 38 preferably spring-loaded and include a manually actuated Ted 38a and eight hook or other detent 38b for engaging a retainer or torsion 42. The resulting lock 38, when engaged, prevents the splitting of the handles unless the Ted 38a are manually depressed to release the retainers 42. Once the lock or latch is opened, the handle 12a, 14a can be pivoted to the positions shown in figs six and seven and folded to reduce the overall length of the cutters. Thanks for the five further exemplify the sequential steps in expanding or collapsing the bulk cutter.

The foregoing is considered as illustrative only of the principles of the invention. Further, since numerous modifications and changes won't readily occur to those skilled in the art, it is not designed to limit the invention to the exact construction and operation shown and described, and accordingly, all suitable modifications and equivalents may be resorted to, falling within the scope of the invention.

1. Collapsible bolt cutter comprising:
A first pair of levers each having opposing ends and a
cutting jaw at one end
and an actuating lever end at the opposing end, said first pair of levers being pivoted to each other at an intermediate positions to arrange said cutting jaws in juxtaposition in scissor-like fashion to cause said jaws to separate when said actuating lever ends are brought closer together and to move into contact with each other when said actuating lever ends are moved away from each other;
a second pair of levers pivoted to each other and having force-applying ends linked to associated actuating lever ends and having handle ends configured to be gripped by a user, said force-applying ends being arranged to separate from each other when said handle ends are urged closer to each other, thereby causing said cutting jaws to move together, said actuating levers and said jaws of said first pair of levers having lengths selected to provide a first mechanical advantage M1 for multiplying forces applied to said actuating lever ends to said jaws and said force-applying ends and said handle ends selected to provide a second mechanical advantage M2 for multiplying forces applied to said handle ends, whereby the total mechanical advantage M=M1×M2 multiplies forces applied to said handle ends to said jaws,
said handle ends being formed of two handle portions pivoted to each other to allow said handle portions of each handle end to pivot between a first extended condition in which said handle portions are substantially aligned along a linear length during use of the bolt cutter and a second collapsed or folded condition in which said handle portions are substantially in parallel juxtaposed folded condition; and
locking means for selectively locking said handle portions in said first extended condition and releasing said handle portions from said locked condition to enable said handle portions to move to said second collapsed or folded condition,
whereby the bolt cutter can be selectively used when said handle portions are secured in said extended condition and effectively shortened in said collapsed or folded condition to be stored.

2. Collapsible bolt cutter as defined in claim 1, wherein said locking means comprises a detent acting between said handle portions.

3. Collapsible bolt cutter as defined in claim 1, wherein said locking means comprises a latch in proximity to where said handle portions are pivoted to each other, a protuberance being formed on one handle portion proximate to said pivoting location of said handle portions and a retainer being formed on an associated other handle portion for engaging said protuberance in locking relationship to prevent said handle portions of each handle end from inadvertently moving from said extended condition during use.

4. Collapsible bolt cutter as defined in claim 3, wherein said latch includes biasing means for urging said retainer to normally continue to engage an associated protuberance.

5. Collapsible bolt cutter as defined in claim 4, wherein each handle end has an outer portion facing away from the other handle end and an inner portion facing toward the other handle, said handle portions of each handle end being pivoted along said outer portion, said retainer being arranged along said inner portion for selective engagement with an associated protuberance.

6. Collapsible bolt cutter as defined in claim 3, wherein said retainer comprises a locking lever pivoted on said other handle portion.

7. Collapsible bolt cutter as defined in claim 6, wherein said locking lever is spring biased to normally automatically engage and lock an associated protuberance when said handle portions are moved to said extended conditions for use.

8. Collapsible bolt cutter as defined in claim 6, wherein said levers include finger engagement portions extending away from said protuberances for easy engagement by a user to quickly and conveniently actuate said locking levers and release said handle portions from each other to allow said handle portions to be moved to said collapsed or folded conditions.

9. Collapsible bolt cutter as defined in claim 1, further comprising limiting means for limiting the extent to which said handle ends may be moved toward each other and therefore also limiting the spacing between said jaws.

10. Collapsible bolt cutter as defined in claim 9, wherein said jaws form cutting edges facing each other and said limiting means is adjusted to prevent movement of said handle ends towards each other when the spacing between said cutting edges is substantially reduced to bring said cutting edges substantially into abutment against each other to prevent damage to said cutting edges.

11. Collapsible bolt cutter as defined in claim 10, wherein said limiting means comprises a spacer extending between said handle portions and having a length substantially equal to the spacing between said handle ends when said cutting edges come into substantial abutment against each other.

12. Collapsible bolt cutter as defined in claim 11, wherein said spacer is adjustable in length.

13. Collapsible bolt cutter as defined in claim 3, wherein each protuberance is in the form of a flat plate formed on a pivoted end of one handle portion and a second flat plate being formed on the other facing handle portion, whereby substantial forces may be transmitted between handle portions when said handle portions are in their extended conditions during use.

14. Collapsible bolt cutter as defined in claim 13, wherein said handle portion pivot point is arranged to maintain said handle portions in their extended conditions when substantial forces are applied to said handles during use, whereby said locking means only needs to be actuated when said handle ends are separated and said handle portions are to be moved to said collapsed or folded conditions for storage after use.
